(19) United States
(12) Patent Application Publication
(10) Pub. No.: US 2026/0135983 A1
(43) Pub. Date: May 14, 2026

(54) SYSTEM OF 3D TELESTRATION ON DIFFERENT PLANES OF DEPTH TO BE USED WITH A 3D MICROSCOPE

(71) Applicant: X-Biomedical, Inc., Bryn Mawr, PA (US)

(72) Inventors: Mario Mischewski, Marthod (FR); Victor Manuel Rangel Lara, Newtown Square, PA (US); Matthew R. Maltese, Wallingford, PA (US)

(73) Assignee: X-Biomedical, Inc., Bryn Mawr, PA (US)

(21) Appl. No.: 19/269,271

(22) Filed: Jul. 15, 2025

Related U.S. Application Data
(60) Provisional application No. 63/671,291, filed on Jul. 15, 2024.

(51) Int. Cl. H04N 13/361; H04N 13/293; H04N 13/327; H04N 13/398

(52) U.S. Cl. CPC H04N 13/361; H04N 13/293; H04N 13/327; H04N 13/398

(57) ABSTRACT

A method for stereoscopic telestration in a 3D display system, and system therefore includes the steps of, and hardware for, aligning a telestration base plane to a reference object visible in a stereoscopic video stream; fusing a telestration overlay at the telestration base plane to ensure accurate depth alignment; and repositioning the telestration overlay to a moved telestration plane in front of or behind the telestration base plane by adjusting left and right eye overlays symmetrically. The repositioning may be performed without losing positional accuracy relative to the stereoscopic image stream.

### BACKGROUND

In surgical training or in-situ consultations, an expert surgeon (mentor) sometimes teaches or directs the novice surgeon (mentee) at the bedside using oral communication, shared viewing of the surgical site, and often the ability for each to put their hands and/or tools in the surgical field. This teaching method allows the mentor to point and gesture as they guide the mentee. In the vernacular of surgery, this is “do one” and “teach one” elements of the “see one, do one, teach one” surgical training paradigm.

Many surgical disciplines use surgical microscopes, where the surgical field is relatively small, making it difficult or possibly dangerous for the mentor and mentee to both put their hands and/or tools on the anatomy in the surgical site. Thus, intraoperative guidance for surgeries that use microscopes has been limited primarily to verbal communication without direct visual guidance from the mentor. Miscommunication, at best, leads to inefficient learning and, at worst, threatens patient safety.

When using video feeds, telestration, the amalgamation of television and illustration, is a teaching tool that shows great promise for surgical microscopy and other professions where the visual field of the primary user is magnified, filtered, enhanced, or otherwise augmented. In telestration, the mentor illustrates to the mentee using a digital drawing device (touch screen tablet, computer mouse, pen, trackball, or similar drawing device coupled with a screen). That is, on the mentor's screen, the mentor can see in real-time the same image stream of the surgical field that the mentee sees, and through the digital drawing device, the mentor can draw lines, arrows, or other markings/filters overlaid upon the surgical field. Simultaneously, the mentee can view the mentor's markings on their digital viewing device, which is also overlaid on the surgical field. The digital viewing device may have the technology to augment the mentee's visual field and can be embedded in and viewed through the oculars of a microscope, or displayed on a screen or in glasses with digital projection capability (smartglasses).

In particular, the evolution of surgical microscopes from solely light transmission to digital vision (CMOS sensors convert light to digital signals that are, in turn, displayed on screens) facilitates telestration in microsurgery.

3D telestration presents a whole new set of possibilities, as well as challenges. Humans see in 3 dimensions because each eye sees an object of interest from two slightly different angles, thus allowing the brain to resolve that some parts of the object are closer or farther away. When an object of interest is viewed using AR/VR glasses, depth perception is tied to a stereoscopic window projected in front of the user. As such, 3D objects are either in front of or behind the stereoscopic window. To avoid visual confusion, the telestration must be projected so that the telestration lines will not “collide” with the 3D object, resulting in the inability to “construct” or “see” the 3D image.

Great care must also be taken to avoid window violations. As window violations are difficult to avoid, the use of dynamic floating windows is often mandatory to prevent visual fatigue. While this technique is mainly used in 3D movies, it is of great help in telestration.

The stereoscopic window violation is a problematic artifact influencing perceived stereoscopic 3D quality. It occurs when depth perception from stereopsis and occlusion depth cues is inconsistent due to interactions with the stereoscopic window border.

The Dynamic Floating Window is a technology used in stereoscopic film and video productions, which dynamically alters the position, orientation, and shape of the virtual proscenium and the resulting stereo window in three-dimensional space.

FIG. 1 illustrates the visual and perceptual consequences of telestration in a stereoscopic augmented reality environment. In the figure, telestration lines are shown extending from the screen plane in relation to multiple points in the 3D scene, including objects A and B. These telestration lines represent the mentor's digital annotations projected into the stereoscopic visual field seen by the mentee through AR or VR glasses. The precise alignment and positioning of these telestration lines are critical to avoiding depth perception artifacts.

The illustration in FIG. 1 distinguishes between zones perceived as comfortable and painful, between zones of window violation (as discussed by Brian Garner in The Dynamic Floating Window—a new creative tool for 3D movies), and correct occlusion on either side of the telestration lines, depending on the stereoscopic disparity created by projecting annotations in front of or behind the screen plane. Specifically, when telestration lines intersect or approach the screen plane improperly closer to the viewing monoculars, this creates a near window violation. This visual artifact results when occlusion cues and stereopsis are in conflict, hindering the mentee's ability to correctly perceive spatial relationships in the surgical field.

### SUMMARY OF THE EMBODIMENTS

A method for stereoscopic telestration in a 3D display system, and system therefore includes the steps of, and hardware for, aligning a telestration base plane to a reference object visible in a stereoscopic video stream; fusing a telestration overlay (220) at the telestration base plane to ensure accurate depth alignment; and repositioning the telestration overlay to a moved telestration plane in front of or behind the telestration base plane by adjusting left and right eye overlays symmetrically. The repositioning may be performed without losing positional accuracy relative to the stereoscopic image stream.

### BRIEF DESCRIPTION OF THE DRAWINGS

FIG. 1 shows an overview of stereoscopic depth perception generally.

FIG. 2 shows repositioning the telestration depth plane.

FIG. 3 shows the setup of the telestration base plane.

FIG. 4 shows the moved telestration plane.

FIGS. 5A-5E show screen shots of an example software system.

FIG. 6 shows a formula capturing the touchpoint coordinates and the absolute position percentages based on the screen size, ensuring consistent positioning.

FIG. 7 shows an overview of the process flow already described to enable the telestration in the system.

FIG. 8 shows an overview of the hardware described herein.

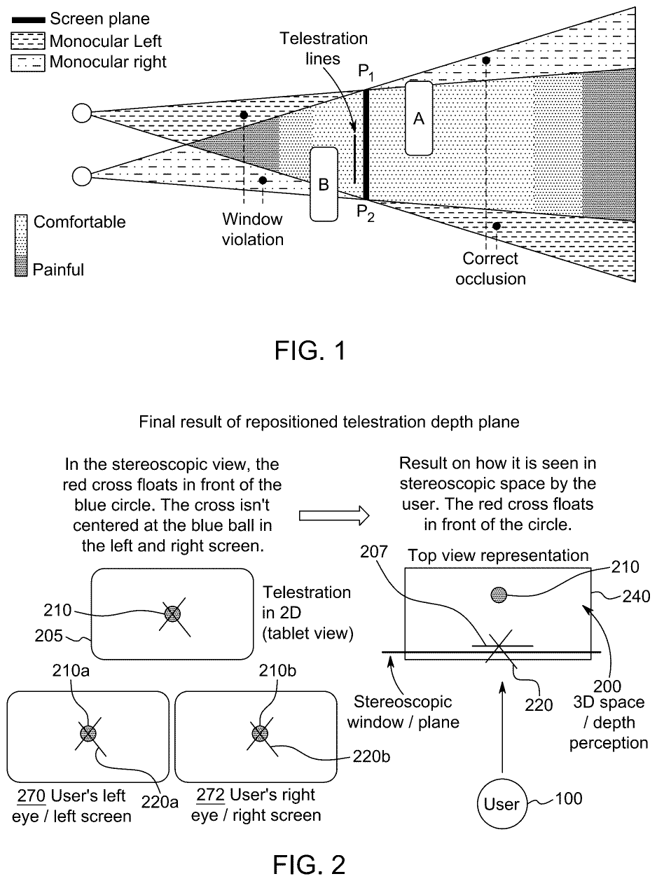

### DETAILED DESCRIPTION OF THE EMBODIMENTS

Telestration as described herein could be used in a surgical visualization system as described in U.S. Pat. No. 10,595,716, which is incorporated herein by reference as if fully set forth herein. Such a system may provide one surgeon (perhaps a mentee) with a surgical visualization headset (which may be opaque or semitransparent) in communication with cameras directed to a surgical site, and a second, perhaps a mentor surgeon, who also receives a video feed from the camera. The second mentor surgeon may have a 3D headset or be viewing on a 2D tablet or screen. And it is this second mentor surgeon who may be providing the below telestration for the mentee.

The telestration being bound to the “zero-plane,” or the stereoscopic window itself, may conflict with a “near” 3D object (by that we mean an object that sticks out from the stereoscopic window towards the viewer). This conflict will prevent the user from fusing the 3D image and the telestration lines.

To allow for a comfortable vision of the telestration lines, three steps are necessary.

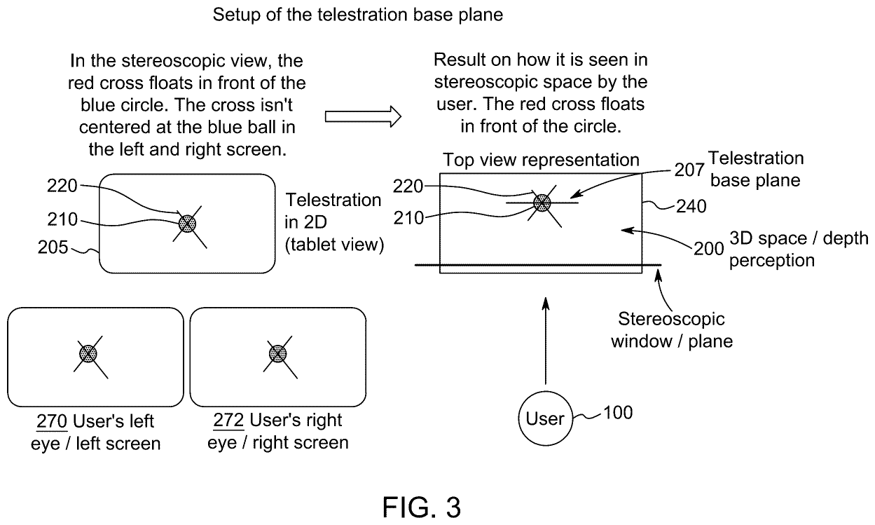

First, as shown in FIG. 2, the telestration are fused for the user's vision. In this step, the user has to fuse geometrical telestation objects. Circles 210, 210, 210b and crossing lines 220, 220a, 220b are best for this step. This can be achieved by moving the left or right screen's telestration object (crosses) so it overlays with the object in the stream (here, the circle). This step aligns the telestration base plane 207 with an object 210 that is easily identifiable by the user, as shown in FIG. 2.

Second, by aligning the telestration base plane 207, as shown in FIG. 3, it is then set at a certain depth within the 3D space 200. For optimal results, the object used to fuse the telestration lines 220 should be closer to the user 100 or the main object (circle) 210 and ideally at the center of the screen 240.

The effect of fusing the telestration lines 210 is assists in precise inputs by the telestrator. The telestrator's 2D information must be precisely transferred in the 3D space 240 for the user 100. For example, in FIG. 3, the telestrator draws a cross 220 at the center of the blue circle 210 in their 2D view (using a tablet) 205. As a result, in the left-side top view within the 3D space 200, the user also sees the red cross 220 at the center of the clue circle 210, but positioned in front of it. In this example, the telestration plane 207 has been moved towards the user 100 and is floating in front of the blue circle 210, but keeps its precise position thanks to the proper setup of the telestration base plane 207.

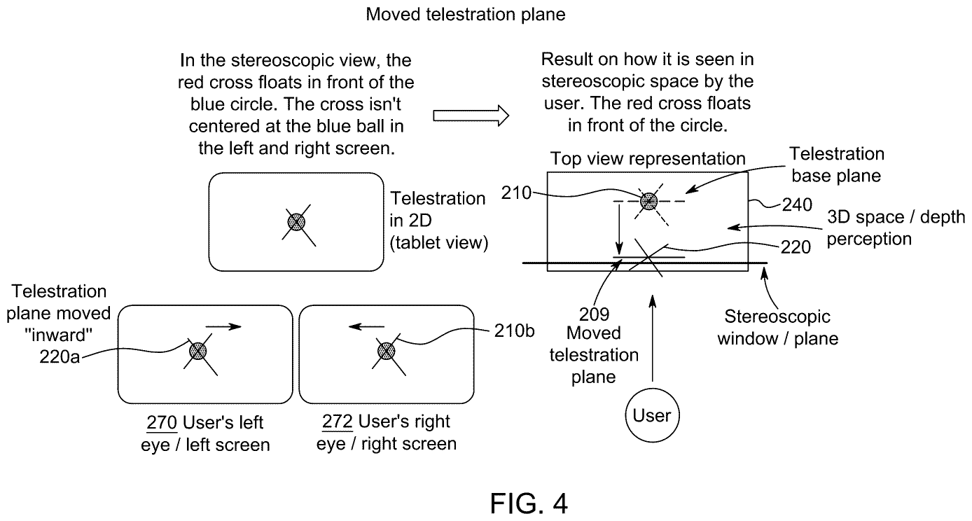

Third, as shown in FIG. 4, once the telestration base plane 207 has been set up, we can now reposition the telestration plane 207 freely without losing precision. This is achieved by repositioning the telestration plane from its base plane position 207 to its moved telestration plane position 209. The moved telestration plane 209 contains the telestration lines 220 or objects symmetrically to an imagined centerline between the left and right screens 270, 272. Moving the left eye's overlay to the right, and the right eye's overlay to the left, moves the telestration plane 209 overlay “inward,” while doing the opposite moves the telestration plane 209 overlay “outward.” It is noted that only the transparent overlay 220a, 220b is repositioned in the screens 270, 272, the stereoscopic stream provided by the cameras doesn't move.

The effect of moving the telestration overlay “inward” moves the telestration plane 209 towards the user, while moving the telestration overlay “outward” moves the telestration plane 209 away from the user 100. While moving the telestration plane 209, the precision of the telestration drawing 220 is kept.

### Operation

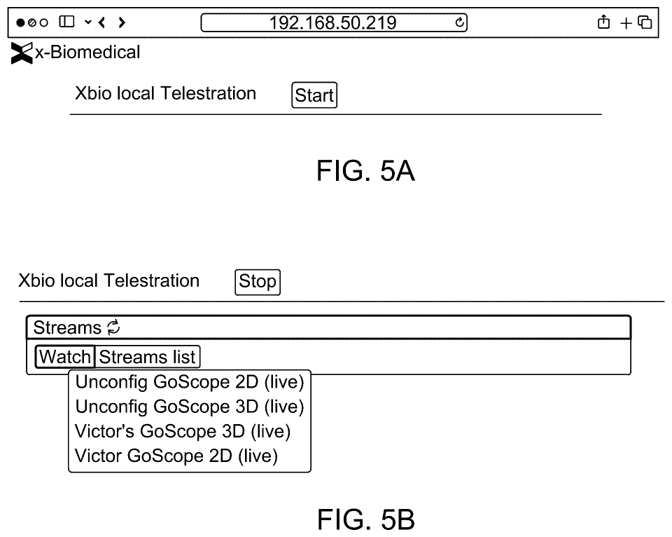

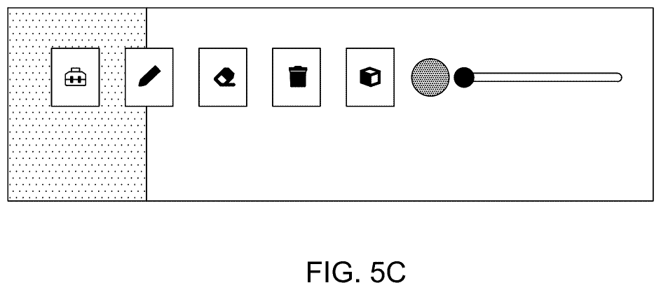

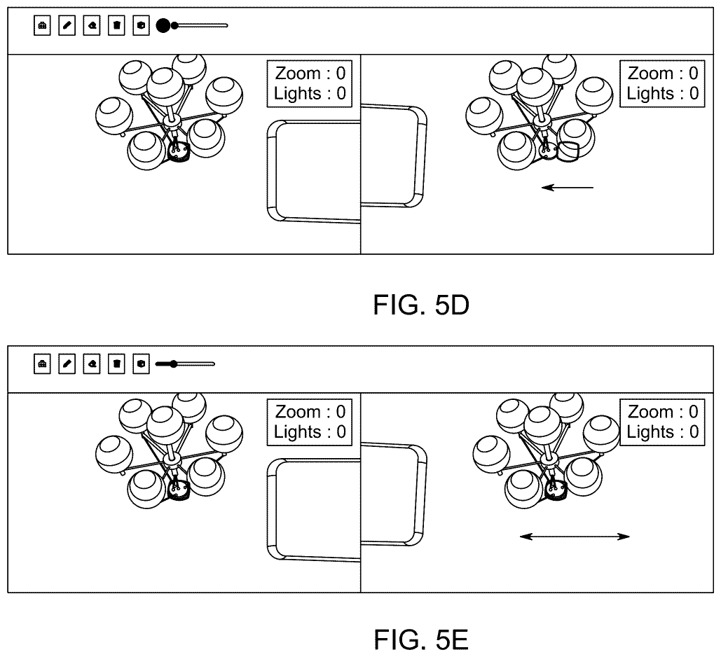

In operation, telestration may be set up for users by following the following steps.
1: Turn on the system including the headsets, connected tablets, and CPUs: Wait for a signal indicating that the system is ready to use. Connect the glasses/headset and set them to a 3D visualization mode.
2: Select a telestration device: Select the device to provide telestration (e.g., tablet or laptop).
3: Connect the telestration device to the headset: This may be done through a network, private network, wired connection, and/or include secure login connection..
4: Access telestration using the telestration device: That may be done by opening a supported link using a web browser, as figuratively shown in FIG. 5A.
5: Join the telestration device to the video stream being sent from the camera to the headset: Click a start button, Select a Stream from the Dropdown Menu and click watch as shown in FIG. 5B.
6: Pencil selection: As shown in FIG. 5C, click the toolbox icon and then a pencil, and the mentor surgeon may use it to draw over the stream on their telestration device. Clicking this may bring up a color picker for selecting the pencil color and a range selector for the stroke size.
7: Draw: The mentor may use the pencil to draw on the left camera. If the drawing is not aligned with the object they want to indicate, it will not be viewed correctly in 3D as viewed by the mentee or other users viewing in 3D, as shown in the following image, the circle on the right image is not aligned with the black base, as shown in FIG. 5D.
8: 3D aligment: The mentor telestrator user selects the 3D Aligment Tool, and a slider appear. Move the slider until the drawing aligns with the object on the right camera as shown in FIG. 5E.

### Components and Tools of the Telestration System

### Overview

The system is a software and hardware system designed to process, integrate, and output video streams with user-generated annotations, optimized for display on 3D glasses in real-time. It processes video inputs from two cameras and integrates user interactions into the video output. The system comprises several key components and processes, detailed as follows:

### Components and Processes

### Video Input Handling

The media engine receives video feeds from at least two cameras.

These at least two video feeds are positioned side-by-side to create the stereoscopic effect for 3D viewing.

### User Interaction and Input:

The telestrator users may interact with the system via a web application running on a tablet or computer.

The system receives drawing commands from the telestrator, which include the type and size of the tool selected (e.g., pencil or eraser), the coordinates of the touchpoint, the type of touch (start, drag, lift), and the specified 3D shift from the telestrator or the viewer.

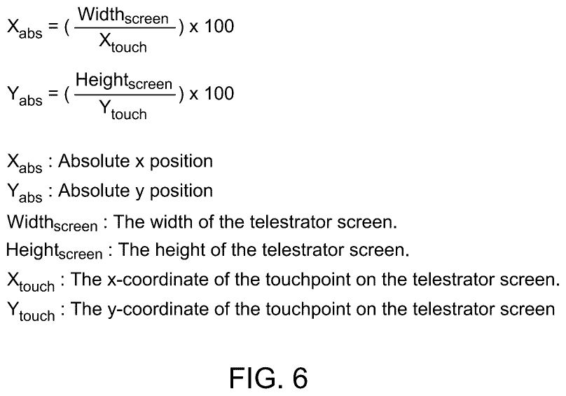

These values are automatically calculated based on the user's interactions with the telestrator screen. The touchpoint coordinates are obtained, and the absolute position percentages are calculated based on the screen size, ensuring consistent positioning regardless of screen dimensions, as shown in the formula shown in FIG. 6.

Using 3D glasses, the viewer user can see in real time the resulting 3D image generated by the engine and the telestrator annotations.

### Tools Available

Besides the cameras, CPU, headsets, tablet, etc, there may be other hardware and software tools available as part of the system.

Pencil: The pencil tool allows users to draw directly on the video. It includes features for color selection and size adjustment.

Fading Drawings: This tool makes annotations temporary by automatically erasing drawings after a set period by the user.

Transparency Drawings: This feature allows users to adjust the transparency of their annotations.

3D Depth Adjustment: This tool enables the adjustment of the 3D position of annotations. Users can set the 3D shift to align their drawings with the desired plane.

Image Attachment: The image attachment feature allows users to insert external images, such as X-rays, into the video stream.

Eraser: The eraser tool is used to remove annotations from the video. It includes size selection.

Clean Screen: The clean screen function clears all annotations from the screen instantly.

### Image Processing With Generic Parallel Processing Unit:

A parallel processing unit (PPU) handles the image processing tasks.

The PPU receives coordinates of touch points and links these coordinates to create interactions on an image texture.

The image texture allows for operations such as erasing, drawing, and resizing elements.

This parallel processing approach ensures ultra-fast processing, adding virtually zero latency to the video streaming.

### Texture and Canvas Updates:

The image texture is updated in the video memory whenever there are changes on the canvas, ensuring real-time responsiveness.

### Frame Processing:

The PPU processes each new video frame.

The PPU incorporates image texture/canvas content into the video frame.

The content is duplicated on both sides of the image to support the 3D effect.

The system allows a user-defined shift to be applied to the duplicated content, enhancing the 3D viewing experience.

### Output to 3D Glasses/Headset:

The processed frames are sent to 3D glasses for display, ensuring the final output is suitable for immersive viewing.

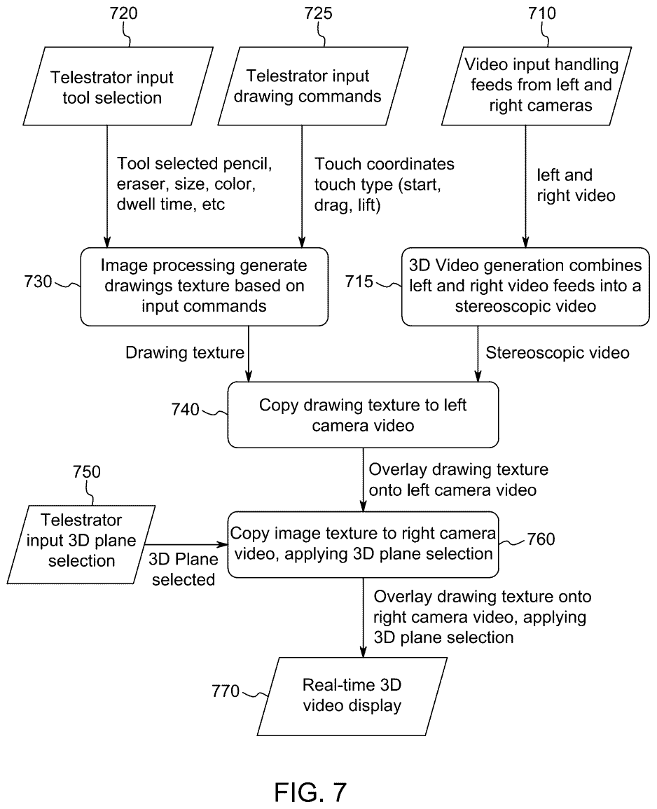

FIG. 7 shows an overview of the process flow already described to enable the telestration in the system. On the right side of the process flow, video input feeds from the left and right cameras 710 feed into 3D video generation engine that combines the left and right feeds to create a stereoscopic video feed 715 for the mentee/surgeon.

On the left side of this process flow, a mentor user selects their telestrator input tool 720 and may also engage certain drawing commands 725. Based on the input tool and commands, the telestration texture is created 730, and the telestration texture is created on the left (or right) camera view 740.

In parallel, the telestrator 3D plane is selected 750, and the image texture is copied onto the right camera video (or left depending on the step 740) and the 3D pane selection is also applied 760. Once the image texture has been copied and the 3D plane applied, the real-time 3D video display with telestration can be fed to the mentee 770.

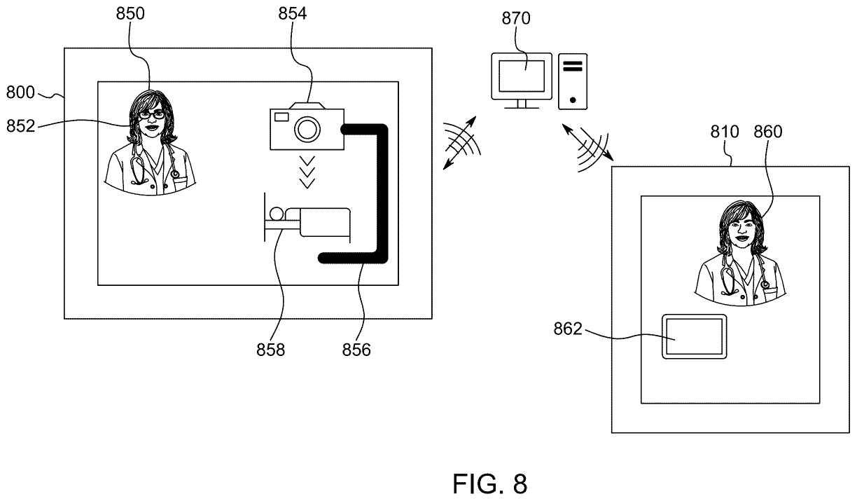

FIG. 8 shows an overview of the hardware used in this system, some details of which are also described in U.S. Pat. No. 10,595,716. In the system in use with a mentor 850 and mentee 860, with each being remote from one another in an operating setting 800 and teaching environment 810. The mentor 850 wears the headset glasses 852 connected to the camera 854 mounted on the stand 856 that streams 3D visual data looking down on the patient 858.

The headset glasses 852 transmits and receives data to/from a CPU rendering engine 870, in which the processing described herein takes place, that may be local to either location or remote to both, or even incorporated into one or both of the headset glasses 852 and/or tablet 862. The mentor 860 may view the streamed visual data in 2 dimensions on a tablet 862 or their own headset in 2 or 3 dimensions. The mentor can mark, adjust, and filter the visual data stream view through their tablet 862, which in turn can transmit the telestration markup back to the CPU 870, which transmits the data back to the headset glasses 852.

Further features may include voxel map generation, using a 3D scanner to recreate the 3D elements that the cameras are looking at (for example, a tooth), and enabling real 3D-shaped telestration, where the telestration lines are bound to the 3D shape.

This telestration system has been demonstrated in the surgical field but it could be used for any scope system, like for example in the electronic component manufacture industry.

### EMBODIMENTS

Embodiment 1. A method for stereoscopic telestration in a 3D display system, comprising:
(a) aligning a telestration base plane (207) to a reference object (210) visible in a stereoscopic video stream (200);
(b) fusing a telestration overlay (220) at the telestration base plane (207) to ensure accurate depth alignment; and
(c) repositioning the telestration overlay (220) to a moved telestration plane (209) in front of or behind the telestration base plane (207) by adjusting left and right eye overlays (270, 272) symmetrically,
wherein the repositioning is performed without losing positional accuracy relative to the stereoscopic image stream.

Embodiment 2. The method of embodiment 1, wherein the telestration overlay includes one or more geometric primitives selected from the group consisting of circles, crosses, and arrows.

Embodiment 3. The method of embodiment 1, wherein aligning the telestration base plane includes overlaying a telestration object (220) precisely at the center of the reference object (210) in both left and right eye views.

Embodiment 4. The method of embodiment 1, wherein the step of repositioning is performed using a 3D alignment tool comprising a slider interface.

Embodiment 5. The method of embodiment 1, wherein the telestration overlay (220a, 220b) is moved “inward” towards a user's perception by shifting the left overlay (270) to the right and the right overlay (272) to the left.

Embodiment 6. The method of embodiment 1, wherein the telestration overlay is repositioned “outward” away from a user's perception to appear deeper within the stereoscopic scene by shifting the overlays in the opposite direction.

Embodiment 7. The method of embodiment 1, wherein the telestration base plane (207) is selected to avoid stereoscopic window violations caused by overlapping near-field objects.

Embodiment 8. The method of embodiment 1, further comprising the step of adjusting transparency of telestration drawings to enhance visual clarity.

Embodiment 9. The method of embodiment 1, wherein repositioning avoids visual fatigue associated with window violations in stereoscopic display.

Embodiment 10. The method of embodiment 1, wherein the telestration base plane is aligned to a stereoscopic zero-plane defined by the screen plane of the video display.

Embodiment 11. A system for stereoscopic telestration in augmented or virtual reality, comprising:
a stereoscopic video input stream from dual cameras;
a telestration interface (205) configured to receive drawing inputs from a user;
a rendering engine configured to:
(a) align telestration drawings (220) to a telestration base plane (207) using visual references such as circles (210);
(b) project the drawings onto both left and right image planes (270, 272); and
(c) shift the drawings symmetrically inward or outward to form a moved telestration plane (209) closer to or further from the user (100),
wherein the system preserves stereoscopic alignment during and after repositioning of the telestration plane.

Embodiment 12. The system of embodiment 11, wherein the rendering engine includes a parallel processing unit configured to update an image texture in video memory in real time.

Embodiment 13. The system of embodiment 11, further comprising a 3D glasses output module for presenting the stereoscopic display to the user (100) with the telestration overlay.

Embodiment 14. The system of embodiment 11, wherein the telestration interface (205) includes a color selector and stroke size adjustment for drawing tools.

Embodiment 15. The system of embodiment 11, wherein the rendering engine is configured to receive inputs including touchpoint coordinates, drawing type, and 3D depth shift parameters.

Embodiment 16. The system of embodiment 11, wherein the drawing inputs are processed as percentages of the telestrator screen size for consistent rendering across display dimensions.

Embodiment 17. The system of embodiment 11, wherein the system further includes a dynamic floating window mechanism for repositioning the stereoscopic window.

Embodiment 18. The system of embodiment 11, wherein annotations fade automatically after a preset duration set by the user.

Embodiment 19. The system of embodiment 11, wherein telestration elements are bound to a voxel map generated from a 3D scan of the surgical field.

Embodiment 20. The system of embodiment 11, wherein the dual camera streams are arranged side-by-side to simulate binocular stereoscopic vision.

While the invention has been described with reference to the embodiments above, a person of ordinary skill in the art would understand that various changes or modifications may be made thereto without departing from the scope of the claims.

I/We claim:

1. A method for stereoscopic telestration in a 3D display system, comprising:
(a) aligning a telestration base plane (207) to a reference object (210) visible in a stereoscopic video stream (200);
(b) fusing a telestration overlay (220) at the telestration base plane (207) to ensure accurate depth alignment; and
(c) repositioning the telestration overlay (220) to a moved telestration plane (209) in front of or behind the telestration base plane (207) by adjusting left and right eye overlays (270, 272) symmetrically,
wherein the repositioning is performed without losing positional accuracy relative to the stereoscopic image stream.

2. The method of claim 1, wherein the telestration overlay includes one or more geometric primitives selected from the group consisting of circles, crosses, and arrows.

3. The method of claim 1, wherein aligning the telestration base plane includes overlaying a telestration object (220) precisely at the center of the reference object (210) in both left and right eye views.

4. The method of claim 1, wherein the step of repositioning is performed using a 3D alignment tool comprising a slider interface.

5. The method of claim 1, wherein the telestration overlay (220a, 220b) is moved “inward” towards a user's perception by shifting the left overlay (270) to the right and the right overlay (272) to the left.

6. The method of claim 1, wherein the telestration overlay is repositioned “outward” away from a user's perception to appear deeper within the stereoscopic scene by shifting the overlays in the opposite direction.

7. The method of claim 1, wherein the telestration base plane (207) is selected to avoid stereoscopic window violations caused by overlapping near-field objects.

8. The method of claim 1, further comprising the step of adjusting transparency of telestration drawings to enhance visual clarity.

9. The method of claim 1, wherein repositioning avoids visual fatigue associated with window violations in stereoscopic display.

10. The method of claim 1, wherein the telestration base plane is aligned to a stereoscopic zero-plane defined by the screen plane of the video display.

11. A system for stereoscopic telestration in augmented or virtual reality, comprising:
a stereoscopic video input stream from dual cameras;
a telestration interface (205) configured to receive drawing inputs from a user;
a rendering engine configured to:
(a) align telestration drawings (220) to a telestration base plane (207) using visual references such as circles (210);
(b) project the drawings onto both left and right image planes (270, 272); and
(c) shift the drawings symmetrically inward or outward to form a moved telestration plane (209) closer to or further from the user (100),
wherein the system preserves stereoscopic alignment during and after repositioning of the telestration plane.

12. The system of claim 11, wherein the rendering engine includes a parallel processing unit configured to update an image texture in video memory in real time.

13. The system of claim 11, further comprising a 3D glasses output module for presenting the stereoscopic display to the user (100) with the telestration overlay.

14. The system of claim 11, wherein the telestration interface (205) includes a color selector and stroke size adjustment for drawing tools.

15. The system of claim 11, wherein the rendering engine is configured to receive inputs including touchpoint coordinates, drawing type, and 3D depth shift parameters.

16. The system of claim 11, wherein the drawing inputs are processed as percentages of the telestrator screen size for consistent rendering across display dimensions.

17. The system of claim 11, wherein the system further includes a dynamic floating window mechanism for repositioning the stereoscopic window.

18. The system of claim 11, wherein annotations fade automatically after a preset duration set by the user.

19. The system of claim 11, wherein telestration elements are bound to a voxel map generated from a 3D scan of the surgical field.

20. The system of claim 11, wherein the dual camera streams are arranged side-by-side to simulate binocular stereoscopic vision.
